(19) United States
(12) Patent Application Publication
(10) Pub. No.: US 2025/0166109 A1
(43) Pub. Date: May 22, 2025

(54) DEPARTURE TIME ADJUSTMENT METHOD, STORAGE MEDIUM, VEHICLE-MOUNTED CONTROLLER AND RAIL VEHICLE

(71) Applicant: BYD COMPANY LIMITED, Shenzhen (CN)

(72) Inventors: Qiongfang WANG, Shenzhen (CN); Chujun Chen, Shenzhen (CN); Kaikuo Zhuo, Shenzhen (CN); Weihua Liu, Shenzhen (CN)

(21) Appl. No.: 19/036,328

(22) Filed: Jan. 24, 2025

Related U.S. Application Data
(63) Continuation of application No. PCT/CN2023/097642, filed on May 31, 2023.

(30) Foreign Application Priority Data
Jul. 25, 2022 (CN) 202210878389.4

(51) Int. Cl. G06Q 50/40

(52) U.S. Cl. CPC G06Q 50/40

(57) ABSTRACT

A departure time adjustment method includes: acquiring preceding vehicle information corresponding to a resource device required by a target vehicle on a route to be traveled, a preceding vehicle which corresponds to the preceding vehicle information representing a vehicle which uses the resource device before the target vehicle uses the resource device; establishing communications with the preceding vehicle according to the preceding vehicle information, and acquiring a predicted end time in which the preceding vehicle uses the resource device; determining a predicted driving time in which the target vehicle drives to the resource device; and adjusting a departure time of the target vehicle according to the predicted end time, the predicted driving time and a planned parking time of the target vehicle.

### CROSS-REFERENCE TO RELATED APPLICATIONS

The present disclosure is a bypass continuation of PCT International Application No. PCT/CN2023/097642, filed on May 31, 2023, which claims priority to and benefits of Chinese Patent Application No. 202210878389.4, filed on Jul. 25, 2022 and entitled “METHOD FOR ADJUSTING DEPARTURE TIME, STORAGE MEDIUM, VEHICLE ON-BOARD CONTROLLER, AND RAIL VEHICLE”. The entire contents of the above-referenced applications are incorporated herein by reference.

### FIELD

The present disclosure relates to the field of vehicle dispatching technologies, and specifically, to a method for adjusting departure time, a storage medium, a vehicle on-board controller, and a rail vehicle.

### BACKGROUND

Currently, in the rail transport industry, a departure time of a rail train is controlled mainly by a communications-based train control (CBTC) system. After the rail train stops at a platform, a departure countdown is performed according to a station parking time sent by an automatic train supervision (ATS) system, and the rail train departs after the countdown ends. In addition, the automatic train supervision system usually adjusts the station parking time of the current platform according to an operating time of the rail train in a previous operating interval. For example, if the operating time in the previous operating interval times out, the station parking time of the rail train in the current platform is reduced.

However, after the rail train departs, if it is found that a trackside device required on a preceding to-be-traveled route is occupied by another train and cannot be used, the rail train has to stop in the operating interval. In case of emergency, it is very inconvenient to rescue or evacuate passengers.

### SUMMARY

An objective of the present disclosure is to provide a method for adjusting departure time, a storage medium, a vehicle on-board controller, and a rail vehicle.

To achieve the foregoing objective, a first aspect of the present disclosure provides a method for adjusting departure time. The method includes:

Preceding vehicle information corresponding to a resource device required by a target vehicle on a to-be-traveled route is obtained. A preceding vehicle corresponding to the preceding vehicle information represents a vehicle that uses the resource device before the target vehicle uses the resource device.

Communication is established with the preceding vehicle according to the preceding vehicle information, and a predicted end time in which the preceding vehicle uses the resource device is obtained.

A predicted traveling time in which the target vehicle travels to the resource device is determined.

A departure time of the target vehicle is adjusted according to the predicted end time, the predicted traveling time, and a planned parking time of the target vehicle.

In some embodiments, that a departure time of the target vehicle is adjusted according to the predicted end time, the predicted traveling time, and a planned parking time of the target vehicle includes:

A first time difference between the predicted end time and the predicted traveling time is determined.

The departure time of the target vehicle is adjusted according to a maximum value of the first time difference and the planned parking time.

In some embodiments, that a departure time of the target vehicle is adjusted according to the predicted end time, the predicted traveling time, and a planned parking time of the target vehicle includes:

A total time of the planned parking time and the predicted traveling time is determined. A second time difference between the predicted end time and the total time is determined.

The departure time of the target vehicle is adjusted according to the second time difference and the planned parking time of the target vehicle.

In some embodiments, that the departure time of the target vehicle is adjusted according to the second time difference and the planned parking time of the target vehicle includes:
if the predicted end time is less than or equal to the total time, the departure time is a departure time determined according to the planned parking time; or
if the predicted end time is greater than the total time, the departure time is adjusted according to a sum of the planned parking time and the second time difference.

In some embodiments, that preceding vehicle information corresponding to a resource device required by a target vehicle on a to-be-traveled route is obtained includes:

A first query request for the resource device is sent to a vehicle monitoring system.

Preceding vehicle information corresponding to the resource device fed back by the vehicle monitoring system in response to the first query request is received. The preceding vehicle information is determined by the vehicle monitoring system according to the resource device and a preset vehicle operating plan.

In some embodiments, that communication is established with the preceding vehicle according to the preceding vehicle information, and a predicted end time in which the preceding vehicle uses the resource device is obtained includes:

A second query request for the resource device is sent to the preceding vehicle.

A predicted end time in which the preceding vehicle uses the resource device fed back by the preceding vehicle in response to the second query request is received. The predicted end time is determined by the preceding vehicle according to an operating state of the preceding vehicle and usage of the resource device.

In some embodiments, a plurality of resource devices are provided, and that a first time difference between the predicted end time and the predicted traveling time is determined includes:
for each resource device, a difference between the predicted end time in which the preceding vehicle uses the resource device and the predicted traveling time in which the target vehicle travels to the resource device is determined, to obtain a plurality of differences, and a maximum value in the plurality of differences is defined as the first time difference.

In some embodiments, the method further includes:
after that a departure time of the target vehicle is adjusted according to the predicted end time, the predicted traveling time, and a planned parking time of the target vehicle, at an interval of preset duration, the step of obtaining a predicted end time in which the preceding vehicle uses the resource device to the step of adjusting a departure time of the target vehicle according to the predicted end time, the predicted traveling time, and a planned parking time of the target vehicle are re-performed, until the target vehicle successfully departs.

According to a second aspect of the present disclosure, a non-transitory computer-readable storage medium is further provided. The non-transitory computer-readable storage medium has a computer program stored therein. When the program is executed by a processor, the steps of the method according to any one of the first aspect are implemented.

A third aspect of the present disclosure further provides a vehicle on-board controller, including:
a memory, having a computer program stored therein; and
a processor, configured to execute the computer program in the memory to implement the steps of the method according to any of the foregoing first aspect.

A fourth aspect of the present disclosure further provides a rail vehicle, including the vehicle on-board controller described in the third aspect.

Other features and advantages of the present disclosure are described in detail in the following detailed description part.

### BRIEF DESCRIPTION OF THE DRAWINGS

The accompanying drawings are provided for further understanding of the present disclosure and constitute a part of the specification, and explain the present disclosure together with the following specific implementations, but do not constitute a limitation to the present disclosure. In the drawings:

FIG. 1 is a schematic flowchart of a method for adjusting departure time according to an embodiment of the present disclosure;

FIG. 2 is a schematic diagram of communication interaction performed by a target vehicle according to an embodiment of the present disclosure; and

FIG. 3 is a schematic diagram of a vehicle on-board controller according to an embodiment of the present disclosure.

### DETAILED DESCRIPTION

The following describes the specific implementations of the present disclosure in detail with reference to the accompanying drawings. It should be understood that the specific implementations described herein are merely used to describe and explain the present disclosure, but are not intended to limit the present disclosure.

It should be noted that, all actions of obtaining signals, information, or data in the present disclosure are performed in compliance with corresponding data protection regulations and policies of a country and authorization granted by an owner of a corresponding apparatus.

It should be understood that, the steps described in the method implementations of the present disclosure may be performed in a different order and/or in parallel. In addition, the method implementations may include additional steps and/or omit performing shown steps. The scope of the present disclosure is not limited in this aspect. The term “include” and variants thereof used in this specification are open include, that is, “include but are not limited to”. The term “based on” is “at least partially based on”. The term “one embodiment” represents “at least one embodiment”. The term “another embodiment” represents “at least one other embodiment”. The term “some embodiments” represents “at least some embodiments”. Related definitions of other terms are provided in the following descriptions.

It should be noted that, concepts such as “first” and “second” mentioned in the present disclosure are merely used to distinguish between different apparatuses, modules, or units, but are not used to limit an order or a mutual dependence of functions performed by the apparatuses, modules, or units. It should be noted that, modifications such as “one” and “a plurality of” mentioned in the present disclosure are illustrative rather than restrictive. A person skilled in the art should understand that, unless otherwise clearly indicated in the context, the modifications should be understood as “one or more”.

Because normal operating of a rail train is affected by trackside devices such as a preceding operating vehicle, a platform, a track switch, and a switchback track, if the preceding operating vehicle stops and occupies a resource device due to an accidental condition such as fire on a preceding platform, pressing of an emergency stop button, a platform door failure, or another failure, other vehicles cannot operate normally. If the vehicle has departed from the platform, the vehicle has to stop in an operating interval. Especially, because a starting vehicle has no previous operating interval, there is substantially no adjustment space for a departure time.

In this case, if an emergency occurs, for example, a fire in the vehicle requires passenger rescue or evacuation, or a passenger suddenly falls ill and needs to get off the vehicle for treatment, it is inconvenient to rescue or evacuate passengers if the vehicle has to stop in the interval, which causes low efficiency and high costs.

Therefore, the present disclosure provides a method for adjusting departure time, a storage medium, a vehicle on-board controller, and a rail vehicle, to resolve the foregoing problems.

It should be noted that, the method for adjusting departure time provided in the embodiments of the present disclosure may be applied to an automatically driven rail vehicle (train) or a manually driven rail vehicle (train). An execution body of the method may be a vehicle or an electronic device mounted on the vehicle, for example, a vehicle on-board controller (VOBC) of the rail vehicle. This is not limited in the present disclosure.

The following describes detailed embodiments of the technical solutions of the present disclosure.

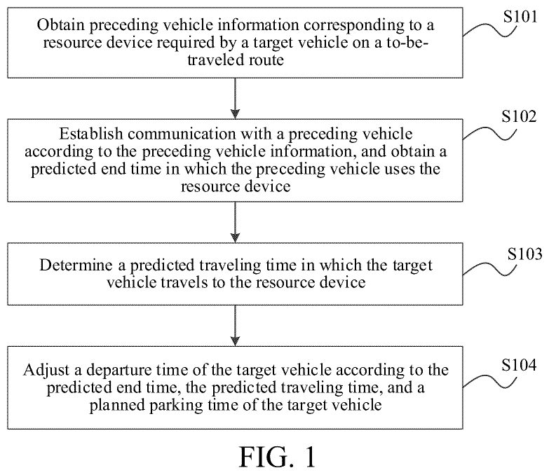

Embodiments of the present disclosure provide a method for adjusting departure time. Referring to FIG. 1, the method includes the following steps.

S101: Preceding vehicle information corresponding to a resource device required by a target vehicle on a to-be-traveled route is obtained.

A preceding vehicle corresponding to the preceding vehicle information represents a vehicle that uses the resource device before the target vehicle uses the resource device.

S102: Communication is established with the preceding vehicle according to the preceding vehicle information, and a predicted end time in which the preceding vehicle uses the resource device is obtained.

S103: A predicted traveling time in which the target vehicle travels to the resource device is determined.

S104: A departure time of the target vehicle is adjusted according to the predicted end time, the predicted traveling time, and a planned parking time of the target vehicle.

According to the foregoing method, communication is performed with the preceding vehicle, and the departure time of the target vehicle is adjusted in combination with the operating condition of the preceding vehicle and the usage of the resource device, so that the vehicle can be prevented from having to stop in the operating interval after the vehicle departs. In other words, when there is a usage conflict of the resource device between the preceding vehicle and the target vehicle, the vehicle stops and waits at the platform, to facilitate passenger rescue or evacuation in case of emergency. In addition, efficiency of passenger rescue or evacuation is improved, and costs are reduced.

To make a person skilled in the art more understand the method for adjusting departure time provided in the present disclosure, the foregoing steps are described in detail below by using examples.

In a possible manner, that preceding vehicle information corresponding to the resource device required by the target vehicle on the to-be-traveled route is obtained may be: A first query request for the resource device is sent to a vehicle monitoring system. Preceding vehicle information corresponding to the resource device fed back by the vehicle monitoring system in response to the first query request is received. The preceding vehicle information is determined by the vehicle monitoring system according to the resource device and a preset vehicle operating plan.

It should be noted that, an example in which the target vehicle is a rail train is used. The vehicle monitoring system is an automatic train supervision (ATS) system, which is responsible for compiling an operating map, automatically arranging a train travel route according to the operating map, automatically adjusting a train operating interval, recording operating data, and the like. The automatic train supervision system records a vehicle operating plan of the rail train and resource devices required for operating, for example, trackside devices such as a platform, a track switch, and a switchback track.

For example, an example in which the target vehicle is the rail train and the execution body is the vehicle on-board controller is used. After the target vehicle stops stably at a platform, the vehicle on-board controller traverses a resource device list of the target vehicle to query a resource device required by the target vehicle from the current platform to a next platform, and the vehicle on-board controller sends queried resource device information, for example, a resource device ID, to an automatic train supervision system to request to query preceding vehicle information corresponding to the required resource device. After receiving a query request including the resource device ID, the automatic train supervision system queries a vehicle operating plan for a current day, and replies, to the vehicle on-board controller of the target vehicle, with preceding vehicle information for the resource device that corresponds to the resource device ID and that is used before the target vehicle. The preceding vehicle information includes a preceding vehicle ID, a train number, a timetable number, and the like. In addition, because rail trains all operate in sequence, for one resource device, generally, the automatic train supervision system only needs to reply with the information corresponding to the preceding vehicle that uses the resource device before the target vehicle.

In a possible manner, that communication is established with the preceding vehicle according to the preceding vehicle information, and a predicted end time in which the preceding vehicle uses the resource device is obtained may be: A second query request for the resource device is sent to the preceding vehicle. A predicted end time in which the preceding vehicle uses the resource device fed back by the preceding vehicle in response to the second query request is received. The predicted end time is determined by the preceding vehicle according to an operating state of the preceding vehicle and usage of the resource device.

For example, after receiving the preceding vehicle information, the vehicle on-board controller establishes a communication connection to the preceding vehicle corresponding to the preceding vehicle ID according to the preceding vehicle ID. The resource device ID is sent to the preceding vehicle. After the preceding vehicle receives the resource device ID, a vehicle on-board controller of the preceding vehicle may calculate, in combination with an automatic train operation (ATO) system and according to the operating state of the vehicle including vehicle position information, operating plan information, and a line speed limit, and the usage of the resource device, the predicted end time in which the resource device is used, and reply to the target vehicle.

It should be noted that, there may be a plurality of resource devices required for the target vehicle to travel from the current platform to the next platform, and there may be one or more preceding vehicles corresponding to the plurality of resource devices. If there are a plurality of preceding vehicles corresponding to the plurality of resource devices, communication is established with the plurality of preceding vehicles separately. In this embodiment of the present disclosure, vehicle-to-vehicle communication may be performed between vehicles based on a train autonomous control system (TACS).

In addition, the rail train switches back and operates, that is, after the preceding vehicle reaches a destination, the rail train switches back and operates. Therefore, in this case, although the preceding vehicle is a previous vehicle that uses the resource device required by the target vehicle, because tracks on which the vehicle switches back and operates are different, there is no usage conflict of the resource device between the preceding vehicle and the target vehicle. To avoid wastes of communication resources and computing resources caused by querying and calculating the predicted end time in which the resource device is used in this case, when the target vehicle performs vehicle-to-vehicle communication with the preceding vehicle, the preceding vehicle may be requested to send a train number and a timetable number. If the train number and the timetable number are inconsistent with a train number and a timetable number sent by the automatic train supervision system, it indicates that the preceding vehicle is a switchback vehicle, and there is no need to send the second query request for the resource device to the preceding vehicle. If the train number and the timetable number are consistent with the train number and the timetable number sent by the automatic train supervision system, it indicates that there may be a usage conflict of the resource device between the target vehicle and the preceding vehicle, and the second query request for the resource device is sent to the preceding vehicle.

It should be noted that, the predicted end time in which the resource device is used sent by the preceding vehicle may be a specific end moment, for example, 13:02:51, which indicates that the preceding vehicle ends using the resource device at 13:02:51. The predicted end time may alternatively be predicted end duration calculated based on a current moment, for example, three minutes and two seconds, which indicates that the preceding vehicle ends using the resource device after three minutes and two seconds. This is not limited in the present disclosure. After the target vehicle receives the predicted end time in which the resource device is used sent by the preceding vehicle, the vehicle on-board controller of the target vehicle may calculate, in combination with the automatic train operation system and according to the information including the vehicle position information, the operating plan information, the line speed limit, and a distance from the resource device, the predicted traveling time in which the target vehicle reaches the resource device. The predicted traveling time may be a specific moment, or may be predicted travel duration calculated based on a current moment. This is not limited in the present disclosure. In addition, if the predicted end duration and the predicted travel duration are calculated, because a communication time and a calculation time of the target vehicle and the preceding vehicle are short, a difference between current times of the target vehicle and the preceding vehicle may be ignored. Alternatively, when a requirement on accuracy is high, the current times of the target vehicle and the preceding vehicle may be recorded, and an error is eliminated through calculation. This is not limited in the present disclosure.

An embodiment is described below by using an example in which the predicted end time sent by the preceding vehicle is the predicted end duration and the predicted traveling time determined by the target vehicle is the predicted travel duration.

In a possible manner, that a departure time of the target vehicle is adjusted according to the predicted end time, the predicted traveling time, and a planned parking time of the target vehicle may be: A first time difference between the predicted end time and the predicted traveling time is determined. The departure time of the target vehicle is adjusted based on a maximum value of the first time difference and the planned parking time.

For example, the first time difference between the predicted end time and the predicted traveling time is calculated. For example, if the preceding vehicle finishes using the resource device after three minutes, and the target vehicle may travel to the resource device in two minutes, the first time difference is one minute. For another example, if the preceding vehicle finishes using the resource device after two minutes, and the target vehicle may travel to the resource device in three minutes, the first time difference is −1 minute. In this case, because there is no conflict, the first time difference may alternatively be set to 0. If the first time difference is one minute, the vehicle needs to stop for at least one minute relative to the current time, to avoid the usage conflict of the resource device. Further, the planned parking time of the vehicle (which refers to a current remaining parking time of the vehicle, that is, a current countdown of a station parking time delivered by the ATS) is compared with the first time difference. If the first time difference is less than or equal to the planned parking time, indicating that the target vehicle does not conflict, when departing after the countdown of the planned parking time ends, with the preceding vehicle in using the resource device, the target vehicle may be counted down according to the planned parking time, and departs normally. If the first time difference is greater than the planned parking time, indicating that the target vehicle conflicts, when departing after the countdown of the planned parking time ends, with the preceding vehicle in using the resource device, the target vehicle extends the departure time according to the first time difference, and departs after the countdown of the time corresponding to the first time difference ends. In other words, the departure time of the target vehicle is adjusted according to the maximum value of the first time difference and the planned parking time.

In a possible manner, that a departure time of the target vehicle is adjusted according to the predicted end time, the predicted traveling time, and a planned parking time of the target vehicle may be: A total time of the planned parking time and the predicted traveling time is determined. A second time difference between the predicted end time and the total time is determined. The departure time of the target vehicle is adjusted according to the second time difference and the planned parking time of the target vehicle.

For example, the total time of the planned parking time and the predicted traveling time is calculated, and the second time difference between the predicted end time and the total time is calculated. For example, the preceding vehicle finishes using the resource device after three minutes, the target vehicle may travel to the resource device in one minute, and the planned parking time of the target vehicle is one minute. In this case, the total time is two minutes, and the second time difference is one minute. For another example, the preceding vehicle finishes using the resource device after two minutes, the target vehicle may travel to the resource device in two minutes, and the planned parking time of the target vehicle is one minute. In this case, the total time is three minutes, and the second time difference is −1 minute.

Further, in a possible manner, that the departure time of the target vehicle is adjusted according to the second time difference and the planned parking time of the target vehicle may be: If the predicted end time is less than or equal to the total time, the departure time is a departure time determined according to the planned parking time; or if the predicted end time is greater than the total time, the departure time is adjusted according to a sum of the planned parking time and the second time difference.

For example, if the predicted end time is less than or equal to the total time, that is, the second time difference is 0 or a negative number, indicating that the target vehicle does not conflict when departing after the countdown of the planned parking time ends, with the preceding vehicle in using the resource device, the target vehicle may be counted down according to the planned parking time, and departs normally. If the predicted end time is greater than the total time, that is, the second time difference is a positive number, indicating that the target vehicle conflicts, when departing after the countdown of the planned parking time ends, with the preceding vehicle in using the resource device, the target vehicle may adjust the departure time by extending by the duration of the second time difference according to the planned parking time. In other words, the departure time is adjusted according to the sum of the planned parking time and the second time difference.

In a possible manner, a plurality of resource devices are provided, and that a first time difference between the predicted end time and the predicted traveling time is determined includes: For each resource device, a difference between the predicted end time in which the preceding vehicle uses the resource device and the predicted traveling time in which the target vehicle travels to the resource device is determined, to obtain a plurality of differences, and a maximum value in the plurality of differences is defined as the first time difference.

For example, if there are the plurality of resource devices, the target vehicle may obtain the predicted end time in which the preceding vehicle uses each resource device, determine the predicted end time in which the target vehicle travels to each resource device, and then calculate the difference between the predicted end time and the predicted traveling time of each resource device, to obtain the plurality of differences. As long as the target vehicle ensures that the target vehicle does not conflict with the preceding vehicle when using the resource device corresponding to the maximum value in the plurality of differences, it can be ensured that there is no conflict with the preceding vehicle in using another resource device. Therefore, the maximum value in the plurality of differences is defined as the first time difference, and is compared with the planned parking time.

Correspondingly, if there are the plurality of resource devices, the target vehicle may determine a plurality of total times between the planned parking time and a plurality of predicted traveling times; then calculate a difference between the predicted end time of each resource device and the total time, to obtain the plurality of differences and define the maximum value in the plurality of differences as the second time difference; and finally only needs to compare whether the target vehicle conflicts with the preceding vehicle in using the resource device corresponding to the maximum value, and adjusts the departure time according to the sum of the planned parking time and the second time difference when there is a conflict.

In a possible manner, the method further includes: After the a departure time of the target vehicle is adjusted according to the predicted end time, the predicted traveling time, and a planned parking time of the target vehicle, the step of obtaining a predicted end time in which the preceding vehicle uses the resource device to the step of adjusting a departure time of the target vehicle according to the predicted end time, the predicted traveling time, and a planned parking time of the target vehicle are re-performed at an interval of preset duration, until the target vehicle successfully departs.

For example, if the preceding vehicle is in an emergency in a period from the time when the target vehicle stops stably to the time when the target vehicle successfully departs, the predicted end time in which the resource device is used may change. Therefore, the predicted end time in which the preceding vehicle uses the resource device may be periodically obtained, so that when the predicted end time in which the preceding vehicle uses the resource device changes, the departure time can be timely and flexibly adjusted.

It should be noted that, because the vehicle needs to apply for usage permission for the resource device from an object controller (OC) before departing, and the vehicle can depart only after obtaining the usage permission allocated by the OC, the vehicle on-board controller needs to determine that the countdown of the station parking time ends and receive the use permission for the resource device allocated by the OC before the vehicle departs.

To make a person skilled in the art more understand the method steps of the method for adjusting departure time provided in the present disclosure, the following describes a detailed embodiment with reference to a communication process between the target vehicle and the preceding vehicle, the ATS, and the OC.

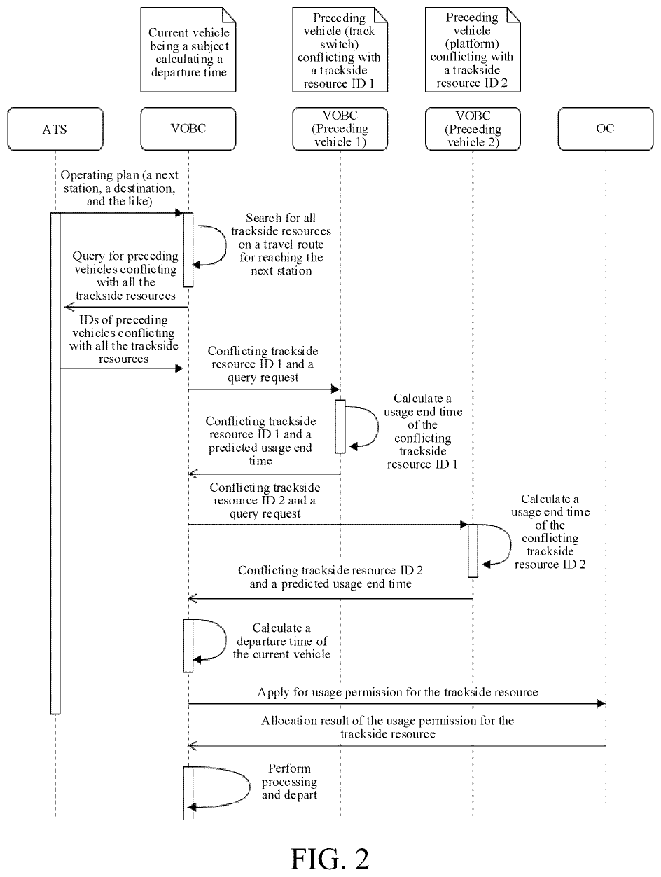

Referring to FIG. 2, a current vehicle (a target vehicle) operates according to an operating plan provided by an ATS. After stopping stably at a platform, the current vehicle searches for each trackside resource (device resource) required on a travel route for reaching a next station and sends the trackside resource to the ATS. After query, the ATS feeds back preceding vehicle information for usage of the trackside resource to the current vehicle. The current vehicle establishes communication with a corresponding preceding vehicle according to the preceding vehicle information, and queries a usage end time (predicted end time) in which the preceding vehicle uses the trackside resource. In FIG. 2, an example in which there are two trackside resources is used. The current vehicle sends a query request to each of a preceding vehicle 1 corresponding to a trackside resource ID 1 and a preceding vehicle 2 corresponding to a trackside resource ID 2. After receiving the query request, each of the preceding vehicle 1 and the preceding vehicle 2 calculates a usage end time of the trackside resource, and feeds back the usage end time to the current vehicle. The current vehicle calculates a departure time of the current vehicle based on a predicted traveling time for the current vehicle to reach the trackside device, a planned parking time, and the usage end time fed back by the preceding vehicle, to avoid a case that the current vehicle is affected by the preceding vehicle and has to stop in an operating interval after the current vehicle departs. Therefore, the current vehicle parks and waits in the platform as much as possible when there is a conflict between the preceding vehicle and the current vehicle in using the resource device. In addition, the current vehicle applies for usage permission for the trackside device from an OC. After the usage permission for the trackside device is obtained and a countdown of a station parking time ends, the current vehicle departs.

Based on a same inventive concept, the embodiments of the present disclosure further provide a non-transitory computer-readable storage medium, having a computer program stored therein, the program, when executed by a processor, implementing the steps of the foregoing method for adjusting departure time.

Based on a same inventive concept, the embodiments of the present disclosure further provide a vehicle on-board controller, including:
a memory, having a computer program stored therein; and
a processor, configured to execute the computer program in the memory, to implement the steps of the foregoing method for adjusting departure time.

Based on a same inventive concept, the embodiments of the present disclosure further provide a rail vehicle, including the foregoing vehicle on-board controller.

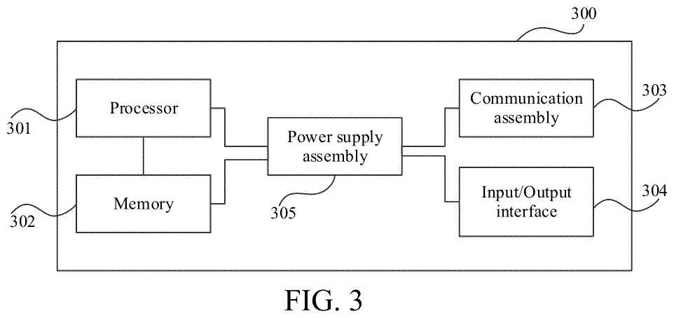

FIG. 3 is a block diagram of a vehicle on-board controller 300 according to an exemplary embodiment. Referring to FIG. 3, the vehicle on-board controller 300 includes one or more processors 301, and a memory 302 configured to store a computer program executable by the processor 301. The computer program stored in the memory 302 may include one or more modules each corresponding to a set of instructions. In addition, the processors 301 may be configured to execute the computer program to perform the foregoing method for adjusting departure time.

In addition, the vehicle on-board controller 300 may further include a power supply assembly 305 and a communication assembly 303. The power supply assembly 305 may be configured to perform power supply management of the vehicle on-board controller 300, and the communication assembly 303 may be configured to implement communication of the vehicle on-board controller 300, for example, wired or wireless communication. In addition, the vehicle on-board controller 300 may further include an input/output (I/O) interface 304. The vehicle on-board controller 300 may operate an operating system stored in the memory 302, such as Windows ServerTM, Mac OS XTM, UnixTM, and LinuxTM.

In another exemplary embodiment, a computer-readable storage medium including program instructions is further provided. The program instructions, when executed by a processor, implement the steps of the foregoing method for adjusting departure time. For example, the non-transitory computer-readable storage medium may be the memory 302 including the program instructions, and the program instructions may be executed by the processor 301 of the vehicle on-board controller 300 to complete the foregoing method for adjusting departure time.

In another exemplary embodiment, a computer program product is further provided. The computer program product includes a computer program executable by a programmable apparatus. The computer program has a code part configured to perform the foregoing method for adjusting departure time when the computer program is executed by the programmable apparatus.

The exemplary embodiments of the present disclosure are described in detail above with reference to the accompanying drawings, but the present disclosure is not limited to the specific details in the above embodiments. Various simple variations may be made to the technical solutions of the present disclosure within the scope of the technical idea of the present disclosure, and such simple variations shall all fall within the protection scope of the present disclosure.

It should be further noted that, the specific technical features described in the above specific embodiments may be combined in any suitable manner without contradiction. To avoid unnecessary repetition, various possible combinations are not further described in the present disclosure.

In addition, the various embodiments of the present disclosure may be combined without departing from the idea of the present disclosure, and such combinations shall also fall within the scope of the present disclosure.

What is claimed is:

1. A method for adjusting departure time, comprising:
obtaining preceding vehicle information corresponding to a resource device required by a target vehicle on a to-be-traveled route, wherein a preceding vehicle corresponding to the preceding vehicle information represents a vehicle that uses the resource device before the target vehicle uses the resource device;
establishing communication with the preceding vehicle according to the preceding vehicle information, and obtaining a predicted end time in which the preceding vehicle uses the resource device;
determining a predicted traveling time in which the target vehicle travels to the resource device; and
adjusting a departure time of the target vehicle according to the predicted end time, the predicted traveling time, and a planned parking time of the target vehicle.

2. The method according to claim 1, wherein the adjusting a departure time of the target vehicle according to the predicted end time, the predicted traveling time, and a planned parking time of the target vehicle comprises:
determining a first time difference between the predicted end time and the predicted traveling time; and
adjusting the departure time of the target vehicle according to a maximum value of the first time difference and the planned parking time.

3. The method according to claim 1, wherein the adjusting a departure time of the target vehicle according to the predicted end time, the predicted traveling time, and a planned parking time of the target vehicle comprises:
determining a total time of the planned parking time and the predicted traveling time, and determining a second time difference between the predicted end time and the total time; and
adjusting the departure time of the target vehicle according to the second time difference and the planned parking time of the target vehicle.

4. The method according to claim 3, wherein the adjusting the departure time of the target vehicle according to the second time difference and the planned parking time of the target vehicle comprises:
if the predicted end time is less than or equal to the total time, the departure time is a departure time determined according to the planned parking time; or
if the predicted end time is greater than the total time, adjusting the departure time according to a sum of the planned parking time and the second time difference.

5. The method according to claim 1, wherein the obtaining preceding vehicle information corresponding to a resource device required by a target vehicle on a to-be-traveled route comprises:
sending a first query request for the resource device to a vehicle monitoring system; and
receiving preceding vehicle information corresponding to the resource device fed back by the vehicle monitoring system in response to the first query request, the preceding vehicle information being determined by the vehicle monitoring system according to the resource device and a preset vehicle operating plan.

6. The method according to claim 1, wherein the establishing communication with the preceding vehicle according to the preceding vehicle information, and obtaining a predicted end time in which the preceding vehicle uses the resource device comprises:
sending a second query request for the resource device to the preceding vehicle; and
receiving a predicted end time in which the preceding vehicle uses the resource device fed back by the preceding vehicle in response to the second query request, the predicted end time being determined by the preceding vehicle according to an operating state of the preceding vehicle and usage of the resource device.

7. The method according to claim 2, wherein a plurality of resource devices are provided, and the determining a first time difference between the predicted end time and the predicted traveling time comprises:
for each resource device, determining a difference between the predicted end time in which the preceding vehicle uses the resource device and the predicted traveling time in which the target vehicle travels to the resource device, to obtain a plurality of differences, and defining a maximum value in the plurality of differences as the first time difference.

8. The method according to claim 1, further comprising:
after the adjusting a departure time of the target vehicle according to the predicted end time, the predicted traveling time, and a planned parking time of the target vehicle, re-performing, at an interval of preset duration, the step of obtaining a predicted end time in which the preceding vehicle uses the resource device to the step of adjusting a departure time of the target vehicle according to the predicted end time, the predicted traveling time, and a planned parking time of the target vehicle, until the target vehicle successfully departs.

9. A non-transitory computer-readable storage medium, having a computer program stored therein, the program, when executed by a processor, implementing the steps of the method according to claim 1.

10. A vehicle on-board controller, comprising:
a memory, having a computer program stored therein; and
a processor, configured to execute the computer program in the memory, to implement the steps of the method according to claim 1.

11. A rail vehicle, comprising the vehicle on-board controller according to claim 10.

12. The method according to claim 2, further comprising:
after the adjusting a departure time of the target vehicle according to the predicted end time, the predicted traveling time, and a planned parking time of the target vehicle, re-performing, at an interval of preset duration, the step of obtaining a predicted end time in which the preceding vehicle uses the resource device to the step of adjusting a departure time of the target vehicle according to the predicted end time, the predicted traveling time, and a planned parking time of the target vehicle, until the target vehicle successfully departs.

13. The method according to claim 3, further comprising:
after the adjusting a departure time of the target vehicle according to the predicted end time, the predicted traveling time, and a planned parking time of the target vehicle, re-performing, at an interval of preset duration, the step of obtaining a predicted end time in which the preceding vehicle uses the resource device to the step of adjusting a departure time of the target vehicle according to the predicted end time, the predicted traveling time, and a planned parking time of the target vehicle, until the target vehicle successfully departs.

14. The method according to claim 4, further comprising:
after the adjusting a departure time of the target vehicle according to the predicted end time, the predicted traveling time, and a planned parking time of the target vehicle, re-performing, at an interval of preset duration, the step of obtaining a predicted end time in which the preceding vehicle uses the resource device to the step of adjusting a departure time of the target vehicle according to the predicted end time, the predicted traveling time, and a planned parking time of the target vehicle, until the target vehicle successfully departs.

15. The method according to claim 5, further comprising:
after the adjusting a departure time of the target vehicle according to the predicted end time, the predicted traveling time, and a planned parking time of the target vehicle, re-performing, at an interval of preset duration, the step of obtaining a predicted end time in which the preceding vehicle uses the resource device to the step of adjusting a departure time of the target vehicle according to the predicted end time, the predicted traveling time, and a planned parking time of the target vehicle, until the target vehicle successfully departs.

16. The method according to claim 6, further comprising:
after the adjusting a departure time of the target vehicle according to the predicted end time, the predicted traveling time, and a planned parking time of the target vehicle, re-performing, at an interval of preset duration, the step of obtaining a predicted end time in which the preceding vehicle uses the resource device to the step of adjusting a departure time of the target vehicle according to the predicted end time, the predicted traveling time, and a planned parking time of the target vehicle, until the target vehicle successfully departs.

17. The method according to claim 7, further comprising:
after the adjusting a departure time of the target vehicle according to the predicted end time, the predicted traveling time, and a planned parking time of the target vehicle, re-performing, at an interval of preset duration, the step of obtaining a predicted end time in which the preceding vehicle uses the resource device to the step of adjusting a departure time of the target vehicle according to the predicted end time, the predicted traveling time, and a planned parking time of the target vehicle, until the target vehicle successfully departs.

18. A non-transitory computer-readable storage medium, having a computer program stored therein, the program, when executed by a processor, implementing the steps of the method according to claim 2.

19. A non-transitory computer-readable storage medium, having a computer program stored therein, the program, when executed by a processor, implementing the steps of the method according to claim 3.

20. A non-transitory computer-readable storage medium, having a computer program stored therein, the program, when executed by a processor, implementing the steps of the method according to claim 4.
